(19) United States
(12) Patent Application Publication
(10) Pub. No.: US 2026/0221908 A1
(43) Pub. Date: Jul. 30, 2026

(54) Method and computing unit for controlling an electric drive with overmodulation compensation

(71) Applicant: Brose Fahrzeugteile SE & Co. Kommanditgesellschaft, Würzburg, Würzburg (DE)

(72) Inventor: Johannes SCHWARZKOPF, Marktheidenfeld (DE)

(73) Assignee: Brose Fahrzeugteile SE & Co. Kommanditgesellschaft, Würzburg, Würzburg (DE)

(21) Appl. No.: 19/145,700

(22) PCT Filed: Dec. 27, 2023
(86) PCT No.: PCT/EP2023/087867

§ 371 Date: Aug. 1, 2025

(30) Foreign Application Priority Data
Jan. 4, 2023 (DE) 10 2023 100 129.9

(51) Int. Cl. H02P 6/10; H02P 21/00; H02P 21/28; H02P 21/36

(52) U.S. Cl. CPC H02P 6/10; H02P 21/28; H02P 21/36; H02P 21/50; H02P 2207/05; H02P 2209/05

(57) ABSTRACT

A method for controlling an electric drive is disclosed, the electric drive is divided into at least a first subsystem and a second subsystem, each having distinct control ranges. Both subsystems share a common stator configured to drive a shared rotor. The method involves acquiring a control vector for the electric drive, detecting a first control value within the first control range of the first subsystem, and detecting a second control value within the second control range of the second subsystem at the time of control vector acquisition. The acquired control vector is then assigned to both subsystems in a specific ratio, ensuring that the first control value does not exceed the maximum control range of the first subsystem and/or the second control value does not exceed the maximum control range of the second subsystem.

### CROSS-REFERENCE TO RELATED APPLICATIONS

This application is the U.S. National Phase of PCT/EP2023/087867 Filed Dec. 27, 2023, which claims Priority to DE 10 2023 100 129.9 Filed Jan. 4, 2023, the entire disclosures of which are incorporated by reference herein.

### FIELD OF THE INVENTION

The present disclosure relates to a method for controlling an electric drive with overmodulation compensation. The present invention further relates to a computing unit, to a drive system and to a computer program for controlling an electric drive.

### BACKGROUND

Increased automation and digitalisation necessitate increased use of drives, in particular of brushless DC motors (BLDC), which are becoming increasingly common, leading to new developments in drive regulation systems. In the case of three-phase BLDC drives with a conventional control system, the possible control range of the BLDC drives cannot be fully utilised. This would lead to a departure from sinusoidal control. If the range beyond the control range is used, this leads to a torque ripple which is often not acceptable for the application scenario. Furthermore, the regulability of the system may suffer, leading to disadvantages for use.

It would be worthwhile to improve on this situation.

### SUMMARY

Against this background, the object of the present disclosure is to provide means for controlling electric drives with an appropriate degree of level control.

This object is achieved by a method, a computing unit, a drive system and a computer program as described herein.

Advantageous embodiments and developments will be apparent from the further dependent claims and from the description with reference to the drawings.

In a first aspect, the present disclosure relates to a method for controlling an electric drive. The method comprises the following method steps. In a first step, the electric drive is divided into at least a first subsystem to be controlled having a first control range and a second subsystem to be controlled having a second control range, the first subsystem and the second subsystem having a shared stator and driving a shared rotor of the electric drive. In this context, division according to the present disclosure is understood to mean division of the drive into accordingly equally or differently controllable ranges. Each control range can be loaded/controlled with values in such a way that an appropriate control result is achieved for the drive.

In a further step, the method according to the disclosure comprises the step of acquiring a control vector for controlling the electric drive. For example, the voltage vector for controlling the electric drive is specified and can thus be acquired by the present disclosure. Acquiring may include receiving via an interface. The control vector may be specified by controlling the drive via appropriate interfaces. In particular, the control vector may be specified for a corresponding driving profile of the electric drive. The driving profile may be selected manually or automatically and specified accordingly. By way of example, the electric drive is regulated by means of the control system. The regulation provides a control vector in accordance with a driving profile, such as a required driving profile of the electric drive.

In a further step, a first control value is detected in the control range of the first subsystem to be controlled. Furthermore, a second control value is detected in the second control range of the second subsystem to be controlled. In each case, the detection takes place at the time when the control vector is acquired. By way of example, the first and second detected control value may include a value of a current of the associated subsystem at the time when the control vector is acquired. Detecting the first and second control values may include measuring a current using appropriate measuring means.

In a further step, the method according to the disclosure comprises assigning the acquired control vector to the first subsystem to be controlled and to the second subsystem to be controlled so as to control the electric drive in a specific ratio. The specific ratio refers to the resolution of the control vector into specific components.

This results in the first control value not exceeding a maximum control range of the first subsystem to be controlled and/or the second control value not exceeding a maximum control range of the second subsystem to be controlled.

In one embodiment of the method according to the disclosure, it may be provided that the electric drive is divided into more than two subsystems to be controlled. By way of example, three subsystems to be controlled may be provided. The division of electric drives relates to high-phase systems, the sum of which can be treated as individual three-phase systems. A division into three or more subsystems to be controlled has the advantage that regulation can be provided for each subsystem. This regulation can be evaluated separately, and each subsystem can be addressed and controlled separately. Thus, each subsystem can be handled at the maximum control range in accordance with the driving profile of the electric drive.

In an electric drive with conventional control and limited use of the control range, for example, in electric drives in which a d&q voltage (field-orientated regulation) can be achieved through different phase voltage combinations, the inventors had the idea of providing dynamic adaptation of the control of the electric drives. This makes it possible to make more effective use of the control range of the electric drive and to reduce or prevent the disadvantages of leaving the control range.

In particular, the present disclosure achieves an improvement in the torque ripple, in such a way that the periodic fluctuation of the output torque of the electric drive is reduced. In addition, reducing torque ripple, which can lead to vibrations and audible noise, can improve the acoustics of the electric drive.

Furthermore, the present disclosure can reduce switching losses, adjust the inflection point of the motor characteristic curve to occur later, increase the maximum idling speed, and reduce losses due to field weakening.

In one embodiment, at the same ratio, the maximum control range of the first subsystem to be controlled and the maximum control range of the second subsystem to be controlled may be exceeded for a time range. This has the advantage that, for a specific time range, an increased torque can be called upon from each subsystem and thus an increased total torque can be provided by the electric drive.

In a further embodiment, the drive is configured as a brushless DC motor.

Brushless DC motors are operated with conversion of direct current into suitable three-phase current by control electronics, using excitation by permanent magnets. A three-phase winding, by way of example, is controlled by a suitable circuit so as to generate a moving magnetic field which pulls the permanently excited rotor along. Brushless DC motors offer a wide range of uses.

In a further embodiment, the electric drive has a stator arrangement with twelve stator teeth and a rotor with ten rotor poles (magnet). In one embodiment, the electric drive may have a multiple of the previously mentioned stator teeth and rotor poles. In one or more embodiments, the electric drive can be subdivided into two subsystems. The two subsystems may for example be mutually electrically offset by 30°. Thus, the control range which cannot be mapped by one subsystem can be addressed and/or controlled by the other subsystem as a substitute.

In a further embodiment, one subsystem to be controlled is configured as a master and the further subsystem(s) to be controlled are configured as a slave. The master-slave configuration can be used for load distribution if the subsystems to be controlled drive the electric drive and are thus coupled to the shared load.

In a further embodiment, the electric drive comprises a drive with a number of phases n*3. Here, n indicates the number of phases of the drive and is a natural number ≥2. The present disclosure can be used in electric drives with a number of phases other than 6. In this regard, a wide range of electric drives can be controlled using the present disclosure.

In a further embodiment, assigning the acquired control vector includes maintaining the direction of the control vector and reducing the length of the control vector for a subsystem to be controlled. The reduced control is advantageously compensated by the other subsystem(s), and the torque ripple is thus prevented or reduced.

In a further embodiment, assigning the acquired control vector includes setting a control value to the maximum control range while simultaneously changing the direction of the control vector. Advantageously, a subsystem can thus be operated in the maximum control range, and a maximum torque value can thus be provided. The direction of the control vector can be changed/corrected to a desired direction.

In a further embodiment, for the change of direction, the d or q component is kept constant while a Park transformation is performed, or the α or β component is kept constant while a Clarke transformation is performed. The three-phase variables are converted from the three-phase reference system to the two-axis orthogonal stationary frame of reference using the Clarke transformation. The variables of the two-axis orthogonal stationary frame of reference are transformed into variables of the rotating frame of reference using the Park transformation.

In a further embodiment, the acquired control vector is assigned after an inverse Park transformation has been performed.

In a further embodiment, the control value is set by setting the d-q component or α-β component. This makes it possible to set a limit for the corresponding subsystem.

In a further embodiment, assigning the acquired control vector includes setting a control value to the maximum control range while simultaneously minimising the deviation from the acquired control vector.

In a further embodiment, the acquired control vector is assigned when the pulse duration t of a phase to be switched of the electric drive is t>0% or t<100%. It is advantageous not to have to switch to the phase of this subsystem, even if it is technically possible to do so. The deviation can be compensated by the further subsystem.

In a further embodiment, a subsystem may be operated in particular at the control limit, even if a uniform resolution of the control vector would be possible or can be carried out.

In a second aspect, the disclosure relates to a computing unit for controlling an electric drive. The computing unit comprises a processor unit. The processor unit is configured to divide the electric drive into at least a first subsystem to be controlled having a first control range and a second subsystem to be controlled having a second control range. The first subsystem and the second subsystem have a shared stator and drive a shared rotor of the electric drive.

The computing unit according to the disclosure further comprises a first interface configured to acquire a control vector for controlling the electric drive.

The computing unit according to the disclosure further comprises a second interface. The second interface is configured to detect a first control value in the control range of the first subsystem to be controlled and to detect a second control value in the second control range of the second subsystem to be controlled at the time when the voltage vector is acquired.

The computing unit is configured to assign the acquired control vector to the first subsystem to be controlled and to the second subsystem to be controlled so as to control the electric drive in a specific ratio, in such a way that the first control value does not exceed a maximum control range of the first subsystem to be controlled and the second control value does not exceed a maximum control range of the second subsystem to be controlled.

In a further aspect, the disclosure relates to a drive system comprising an electric drive and a computing unit for controlling the electric drive.

In a further aspect, the disclosure relates to a computer program. The computer program can be loaded to a storage unit of a computing unit according to an aspect of the disclosure, and contains program code portions to cause the computing unit to carry out the method for controlling the electric drive according to the disclosure when the computer program is executed in the computing unit.

The above configurations and developments may be combined as desired, within reason. Further possible embodiments, developments and implementations of the disclosure also include combinations not explicitly mentioned of features of the disclosure which are described above or in the following in relation to the example embodiments. In particular, a person skilled in the art will also add individual aspects to each basic form of the present disclosure as improvements or additions.

### BRIEF DESCRIPTION OF THE DRAWINGS

The present invention is explained in greater detail in the following, with reference to the example embodiments shown in the schematic drawings, in which:

FIG. 1 is an illustration of the computing unit according to one embodiment;

FIG. 2 is a flowchart of the method according to one embodiment,

FIG. 3 is an illustration of the drive system according to one embodiment,

FIG. 4-6 are further illustrations of the method according to one embodiment,

FIG. 7 is an example illustration of the control of a phase of the electric drive according to one embodiment,

FIG. 8 is a further illustration of the control of the electric drive according to one embodiment, and

FIG. 9 is an illustration of a regulation system of the electric drive according to one embodiment.

The accompanying drawings are intended to provide a deeper understanding of the embodiments of the invention. They illustrate embodiments and, in conjunction with the description, serve to explain principles and concepts behind the invention. Other embodiments and many of the stated advantages will become apparent in view of the drawings. The elements of the drawings are not necessarily to scale.

In the drawings, unless stated otherwise, like, functionally equivalent and equivalently acting elements, features and components are provided with like reference numerals.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

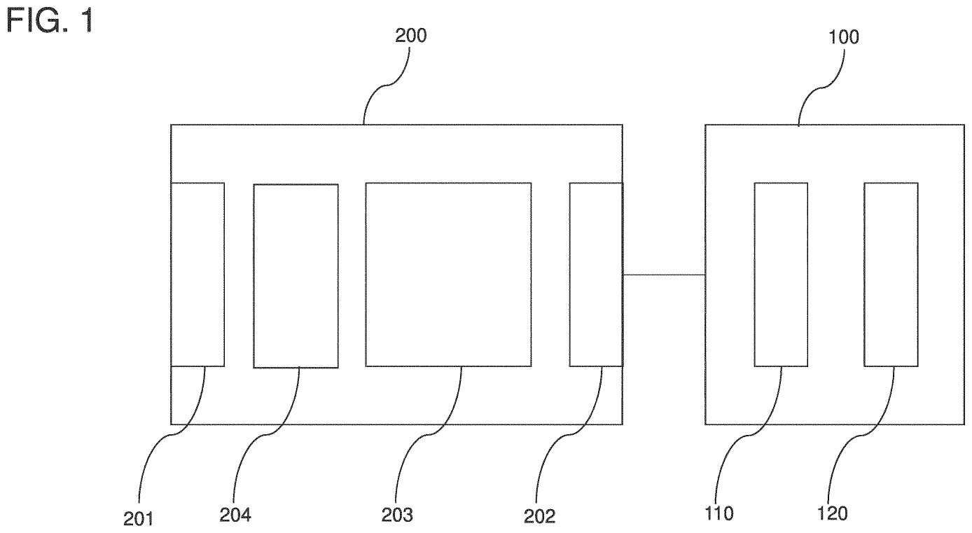

FIG. 1 is a schematic illustration of the computing unit according to one embodiment. In FIG. 1, reference numeral 200 denotes the computing unit for controlling an electric drive 100. The computing unit 200 comprises a processor unit 203. The processor unit 203 is configured to divide the electric drive 100 into at least a first subsystem 110 to be controlled having a first control range and a second subsystem 120 to be controlled having a second control range. In this context, the electric drive 100 is divided into a first subsystem 110 and a second subsystem 120 electrically. The first subsystem 110 and the second subsystem 120 have a shared stator. Furthermore, the first subsystem 110 and the second subsystem 120 jointly drive a rotor of the electric drive 100. The electric drive 100 is not limited to the embodiment shown in FIG. 1. It is further possible for the electric drive 100 to be divided into more than three subsystems 110, 120, . . . , n.

The computing unit 200 further comprises a first interface 201. The first interface 201 is configured to acquire a control vector for controlling the electric drive 100. Furthermore, the computing unit 200 has a second interface 202. The second interface 202 is configured to detect a first control value in the control range of the first subsystem 110 to be controlled at the time when the voltage vector is acquired. Furthermore, the second interface 202 is configured to detect a second control value in the second control range of the second subsystem 120 to be controlled at the time when the voltage vector is acquired.

The computing unit 200 is intended and configured to assign the acquired control vector to the first subsystem 110 to be controlled and to the second subsystem 120 to be controlled so as to control the electric drive 100 in a specific ratio, in such a way that the first control value does not exceed a maximum control range of the first subsystem 110 to be controlled and/or the second control value does not exceed a maximum control range of the second subsystem 120 to be controlled. In particular, the processor unit 203 is configured to perform the assignment of the acquired control vector.

Furthermore, the computing unit 200 has storage means 204 for storing a computer program according to the present disclosure. Furthermore, control-relevant parameters and data for the operation of the electric drive 100 and/or of the drive system 300 may be stored. The storage means 204 may be configured as read-only memory and/or as random access memory and/or as flash memory.

The computing unit 200 may be implemented as a standalone computer unit. Alternatively, the computing unit 200 may be implemented in software and executed on a digital processor and/or microprocessor. Furthermore, the computing unit 200 may be implemented in a programmable logic controller or alternatively be configured as a programmable logic controller. Furthermore, the computing unit 200 may be formed in a motor control system and/or in a frequency converter.

In one embodiment, the computing unit 200 may be arranged local to the electric drive and/or the drive system 300. In a further embodiment, the computing unit 200 may be arranged decentralised from the electric drive and/or from the drive system 300 and communicate with the electric drive 200 and/or the drive system 300 via a communication system.

Furthermore, the computing unit 200 may comprise a man-machine interface (not shown). The man-machine interface is configured for communication between an operator and the computing unit 200, in particular of the drive system 300. For communication, the computing unit 200 comprises further input and/or output means, such as a monitor, a touchscreen, a keyboard and/or a cursor movement means.

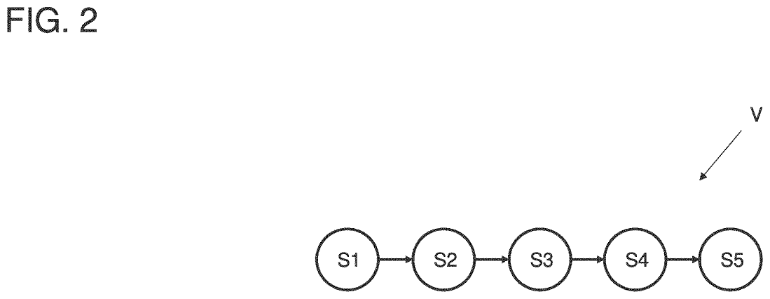

FIG. 2 is a flowchart of a method according to one embodiment. In the embodiment shown, the method V for controlling an electric drive comprises a plurality of method steps. In a first method step S1, the electric drive is divided into at least a first subsystem 110 to be controlled having a first control range and a second subsystem 120 to be controlled having a second control range. The first subsystem 110 and the second subsystem 120 have a shared stator and drive a shared rotor of the electric drive (100).

In a further method step S2, a control vector for controlling the electric drive 100 is acquired.

In a further method step S3, a first control value is detected in the control range of the first subsystem 110 to be controlled, and a second control value is detected S4 in the second control range of the second subsystem 120 to be controlled at the time when the control vector is acquired.

In a further method step, the acquired control vector is assigned S5 to the first subsystem 110 to be controlled and to the second subsystem 120 to be controlled so as to control the electric drive 100 in a specific ratio, in such a way that the first control value does not exceed a maximum control range of the first subsystem 110 to be controlled and/or the second control value does not exceed a maximum control range of the second subsystem 120 to be controlled.

In one embodiment of the method, it is provided that, at the same ratio, the maximum control range of the first subsystem 110 to be controlled and the maximum control range of the second subsystem 120 to be controlled may be exceeded for a time range.

A person skilled in the art will be aware that the sequence of the method steps, in particular as described in the embodiment shown, can also be changed and/or exchanged, within reason. This is possible in particular for method steps S1 to S4, since these can be processed in parallel by the computing unit 100.

In a further embodiment, the method may comprise assigning a control vector for which the direction of the control vector is still maintained. At the same time, the length of the control vector and thus the voltage are shortened, in such a way that a corresponding control value lies in the controllable range and control of the corresponding subsystems 110, 120 of the electric drive 100 is possible.

In a further embodiment, the method may provide that the control vector is selected in such a way that the control vector is mapped to the boundaries of the controllable range and at the same time has the smallest distance or the least deviation from the desired control value.

In a further embodiment, the method may provide that the control vector is selected in such a way that the control vector lies at the boundary of the controllable range and at the same time includes the correction of a desired direction. By way of example, the values for the d or q component or the values for the α or β component may be kept constant.

In a further embodiment, the method may provide that a limitation takes place in the d-q range or in the α or β range.

In a further embodiment, the method may provide that U_{dqMotor} is not distributed equally over the subsystems and that subsequently the non-controllable part of a subsystem is compensated by the other subsystems. Instead, it may be provided that U_{dqMotor} is not divided uniformly. The dividing factor is a function of U_{dqMotor} and θ. By way of example, in a 6-phase electric drive this may give:

$${U}_{dqMotor 1} = {U}_{dqMotor} * f ( {U}_{dqMotor ; θ} ) \qquad ( 1 )$$

$${U}_{dqMotor 2} = {U}_{dqMotor} - {U}_{dqMotor 1}$$

In this case, by way of example, ƒ(U_{dwMotor}; θ) may be implemented using a conventional function or a table.

In an example embodiment, the polar coordinates γ_{dq} and |U_{dqMotor}| are determined from the Cartesian coordinates U_{dqMotor}. The total control angle comes to:

$$δ = {Y}_{dq} + θ \qquad ( 2 )$$

If

$$\vert {U}_{dqMotor} \vert \leq 2 * \frac{{U}_{Bat}}{\sqrt{3}} ,$$

the control vector can be divided uniformly, and f(U_{dqMotor}; θ)=50% can be selected.

Alternatively, ƒ(U_{dqMotor}; θ)≠50% has to be selected at least at times.

In a further embodiment of the method, it may be advantageous not to divide U_{dqMotor} uniformly over the subsystems 110, 120, so as to limit the level control of one of the subsystems.

In a further embodiment of the method, it may be provided that level control of the subsystem is to be limited. In this context, it is advantageous not to divide U_{dqMotor} uniformly over the subsystems, so as (partially) to compensate in advance for the later limitation.

In a further embodiment, it may be provided to compensate for an adaptation of the modulation by a subsystem 110, 120. The adaptation can make current measurement possible.

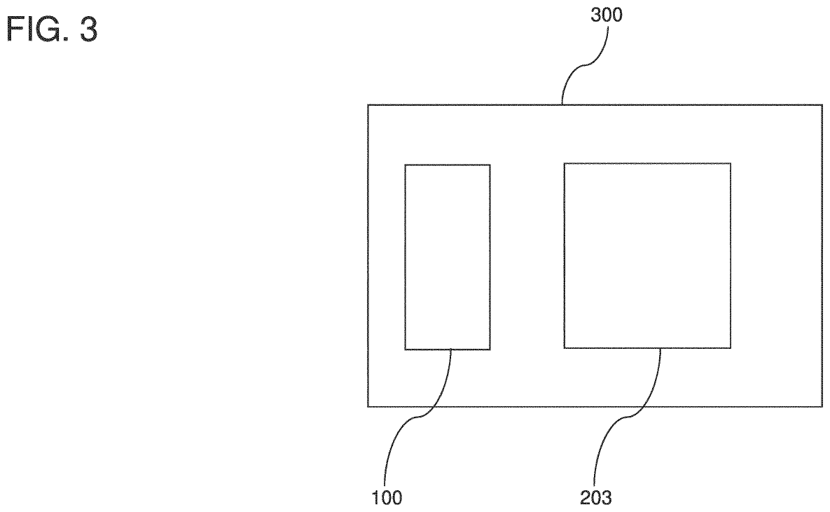

FIG. 3 is an illustration of the drive system 300 according to one embodiment. The drive system 300 has an electric drive 100 and a computing unit 200 according to the disclosure for controlling the electric drive 100. The computing unit 200 is intended to provide control signals for controlling the electric drive 100. The computing unit 200 may be configured as a computer and/or a programmable logic controller and/or frequency converter. The computing unit 200 has interfaces for communication and/or data communication. The computing unit 200 may be arranged centralized or decentralized independently from the electric drive 100. The computing unit 200 is intended to carry out the method according to the disclosure.

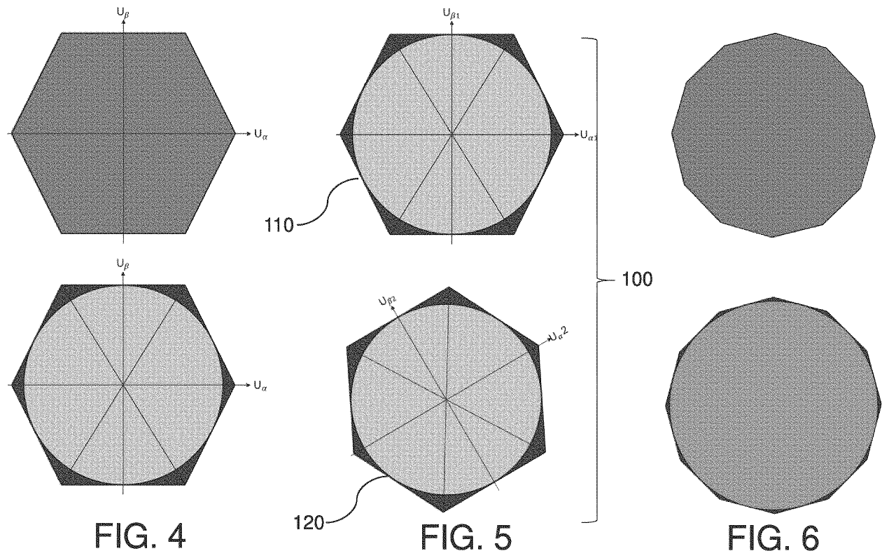

FIG. 4-6 are further illustrations of the method according to one embodiment. With the aforementioned brushless DC motors, the possible control range cannot be fully utilised with a known control system. By means of the Clarke transformation, the phase voltages of the electric drive 100, such as the three phase voltages U, V, W of a subsystem 110, 120 of the electric drive 100, can be converted into two stator-fixed independent variables, preferably into a two-axis coordinate system having the axes a, B. This is given by formula 3:

$$\frac{{U}_{a}}{{U}_{β}} = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] \qquad ( 3 )$$

The controllable range of a subsystem 110, 120 of an electric drive 100 is limited by the intermediate circuit voltage. In the upper image of FIG. 4, the conversion of the phase voltages U, V, W into the two-axis coordinate system can be seen. In particular, the displayable voltage value of the electric drive 100 can be seen from the upper image. In vector regulation or field-orientated regulation (FOC), the electric drive 100 may be advantageously operated in the d-q range. The d-q transformation can be performed using the previously performed Clarke transformation and the parameters

$$\frac{{U}_{a}}{{U}_{β}}$$

acquired from it. The relationship to the

$$\frac{{U}_{a}}{{U}_{β}}$$

range is given by formula 4:

$$[ \frac{{U}_{d}}{{U}_{q}} ] = [ \begin{matrix}cos ( Θ ) & sin ( Θ ) \\ - sin ( Θ ) & cos ( Θ )\end{matrix} ] [ \frac{{U}_{a}}{{U}_{β}} ] \qquad ( 4 )$$

In the case of no temporary limitation and the purely sinusoidal control of a three-phase BLDC, the controllable range shown in the lower image of FIG. 4 comes about. The inner range of the lower image can be controlled with appropriate sinusoidal commutation. The remaining outer ranges, in particular the corners in the hexagon, remain unused in systems known in the art, and are addressed and utilised with the present disclosure. The disclosure can be used in electric drives 100 having a number n of phases not equal to 6. In particular, electric drives 100 having n*3 where n>2 can be used. Furthermore, electric drives 100 are suitable in which a desired d-q voltage can be achieved by different phase voltage combinations.

FIG. 5 shows the control range of two three-phase subsystems 110, 120 of an electric drive 100. Physically, the electric drive 100 can be assessed as a 6-phase electric drive in which two subsystems 110, 120 are regulated separately. The electric drive 100 may be represented for example as a drive having 12 poles and 10 magnets (12/10 drive). The electric drive 100 is subdivided into two subsystems 110, 120 according to formula 5 into:

$${U}_{dMotor} = {U}_{dSys 1} + {U}_{dSys 2} \qquad ( 5 )$$

and

The subsystems 110, 120 shown in FIG. 5 are mutually offset subsystems, offset by 30° by way of example as shown in FIG. 5. In further embodiments, further configurations with a 150° and 210° offset may be used. Thus, the α, β ranges of the two subsystems 110, 120 of the electric drive 100 are rotated by this value relative to one another. The subsystems 110, 120 are treated by the computing unit 100 as mutually independent subsystems 110, 120 of the electric drive 100. The outer regions of the controllable range of the upper and lower hexagon cannot be addressed by methods known in the art. Thus, the physical power of the subsystem 110, 120 or of the electric drive 100 cannot be called upon. With the present disclosure, in the corresponding subsystem 110, 120, at a time when a control vector is acquired, a further torque can be provided by the subsystem 110, 120, in which the outer range of the controllable range has not yet been reached. Thus, for this point in time, more torque can be provided by the subsystem, while the other subsystem only calls up power within the controllable range. An improvement in torque ripple is achieved even when one subsystem is handled in a different controllable range from the other subsystem.

In the upper image of FIG. 6, the sum of the outer areas of the images of FIG. 5 is shown in a dodecagon. In the lower image of FIG. 6, the sum of the inner area of the images of FIG. 5 is shown in a dodecagon. It is found that the diameter of the inner surface is more than twice as large as the inner circle of the subsystems 110, 120. This is given by:

$$\frac{{∅}_{12 E c k}}{2 * {∅}_{6 E c k}} ∼ 1.04 \qquad ( 6 )$$

According to the disclosure, the two subsystems 110, 120 are no longer treated and controlled/regulated in isolation from one another. Thus, the U_{dqMotor} is no longer regulated and uniformly divided over the subsystems 110, 120. This can lead to a subsystem 110, 120 being addressed with voltage values which would result in the controllable range being left, for example if a voltage value for providing a specific torque is applied to the subsystem according to the upper image of FIG. 5. This involves proceeding upwards from the center point. In this context, the upper subsystem 110 has a smaller controllable range than the lower subsystem 120 of FIG. 5. Thus, according to the disclosure, control of a subsystem 110, 120 outside the controllable range can be prevented and, at the same time, torque not yet called upon of the further subsystem can be called upon at this time.

In an example embodiment of the present disclosure, this requires a division of the U_{dqMotor}, for example at 50% each. After an inverse Park transformation is performed, it can be checked whether a desired control vector can be mapped in the ab range of the subsystems 110, 120. If a mapping which involves leaving the controllable range of one of the subsystems 110, 120 is present, U_{dqMotor} is divided in such a way that in total 100%, for example 100% torque, is provided, even though each subsystem 110, 120 is controlling the possible proportion. Advantageously, the torque which cannot be mapped by one subsystem is mapped and controlled by the other subsystem.

By way of example, the voltage in the d direction comes to:

$${U}_{dMotor} = 0 V \qquad ( 7 )$$

By way of example, the voltage in the q direction comes to:

$${U}_{q M o t o r} = 1.17 * {U}_{B a t} \qquad ( 8 )$$

By way of example, the rotor position of the electric drive comes to:

$${Θ}_{M o tor 1} = 0 \qquad ( 9 )$$

$${Θ}_{M o tor 2} = {Θ}_{M o tor 1} + \frac{π}{6} \qquad ( 10 )$$

The inverse Park transformation gives:

$$\frac{{U}_{a 1}}{{U}_{β 1}} = [ \begin{matrix}cos ( {Θ}_{M o tor 1} ) & sin ( {Θ}_{M o tor 1} ) \\ - sin ( {Θ}_{M o tor 1} ) & cos ( {Θ}_{M o tor 1} )\end{matrix} ] [ \begin{matrix}{U}_{qMot o r 1} \\ {U}_{qMot o r 1}\end{matrix} ] \qquad ( 11 )$$

$$and$$

$${U}_{d M o t o r 1} = 0 \qquad ( 12 )$$

$$If$$

$${U}_{d q M o tor 1} = \frac{1}{2} {U}_{d q M o t o r} \qquad ( 13 )$$

were selected, the control value would lie outside the controllable range and the control vector could not be controlled. With the present disclosure, U_{qMotor1} can be set to a value of

$$\frac{{U}_{B a t}}{\sqrt{3}}$$

for the example shown. Here, U_{Bat} describes the voltage of the battery.

$$[ \begin{matrix}{U}_{a 1} \\ {U}_{β 1}\end{matrix} ] = [ \begin{matrix}0 V \\ {U}_{β Max 1}\end{matrix} ] = [ \begin{matrix}0 V \\ {U}_{q Max 1}\end{matrix} ] = [ \begin{matrix}0 V \\ \frac{{U}_{B a t}}{\sqrt{3}}\end{matrix} ] \qquad ( 14 )$$

This results in U_{qMotor2}=U_{qMotor1}−U_{qMotor1}

$$( 1.17 - \frac{1}{\sqrt{2}} * {U}_{B a t} ≅ 5.93 * {U}_{B a t} > \frac{{U}_{B a t}}{\sqrt{3}} \qquad ( 15 )$$

Although

$${U}_{q M o tor 2} > \frac{{U}_{B a t}}{\sqrt{3}} ,$$

the resulting control value can be mapped because it points towards a corner.

$$[ \begin{matrix}{U}_{a 2} \\ {U}_{β 2}\end{matrix} ] = [ \begin{matrix}cos ( {Θ}_{M otor 2} ) & - sin ( {Θ}_{M otor 2} ) \\ sin ( {Θ}_{M otor 2} ) & cos ( {Θ}_{M otor 2} )\end{matrix} ] [ \begin{matrix}{U}_{d M o tor 2} \\ {U}_{d M o tor 2}\end{matrix} ] \qquad ( 16 )$$

$$[ \frac{{U}_{a 2}}{{U}_{β 2}} ] = [ \begin{matrix}cos ( {Θ}_{M otor 2} ) & - sin ( {Θ}_{M otor 2} ) \\ sin ( {Θ}_{M otor 2} ) & cos ( {Θ}_{M otor 2} )\end{matrix} ] [ \begin{matrix}0.296 * & {U}_{B a t} \\ 0.514 * & {U}_{B a t}\end{matrix} ] \qquad ( 17 )$$

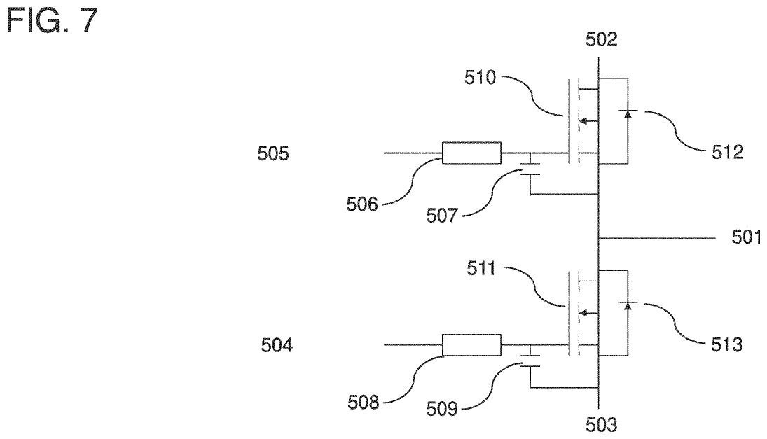

FIG. 7 is an example illustration of the control of a phase 501 of the electric drive 100 according to one embodiment. In the embodiment shown, the switches 510, 511 for switching the phases are implemented by way of MOSFETs. The resistors 506, 508 and capacitors 507, 509 shown are optional. The switch pair is coupled by the switch 510 to the terminal 502 of the positive intermediate circuit voltage and by the switch 511 to the terminal 503 of the negative intermediate circuit voltage or earth. In the shared node, the switches are coupled to the phase contact 501. The switch 510 is coupled at its gate to the high-side control voltage 505. The switch 511 is coupled at its gate to the low-side control voltage 504. Both switches 510, 511 have a diode 512, 513 connected in parallel. The desired voltage value across the switches 510, 511 can be provided to the phase via the high side 505 and the low side 504 in the appropriate time relationship.

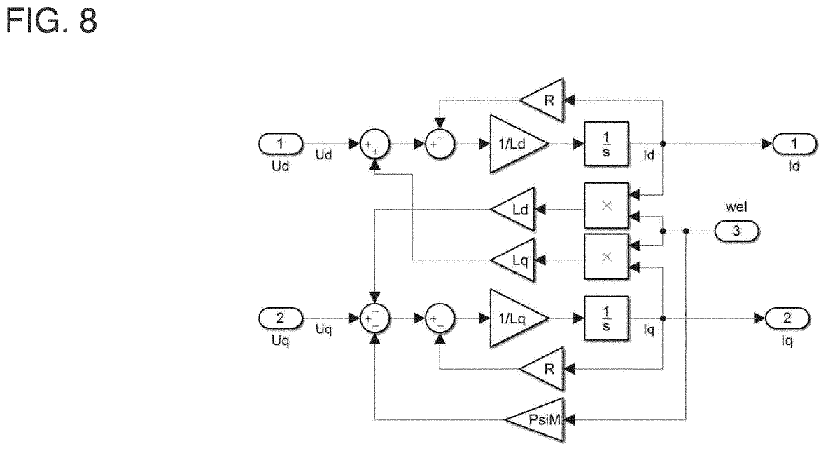

FIG. 8 is a further illustration of the control of the phase of the electric drive 100 according to one embodiment. As an example, the transformation is shown in the dq coordinate system. U_{d} and U_{q} are the voltages in the d direction and q direction. I_{d} and I_{q} are the currents in the d direction and q direction. L_{d} and L_{q} represent the inductances in the d direction and q direction. R are corresponding phase resistances.

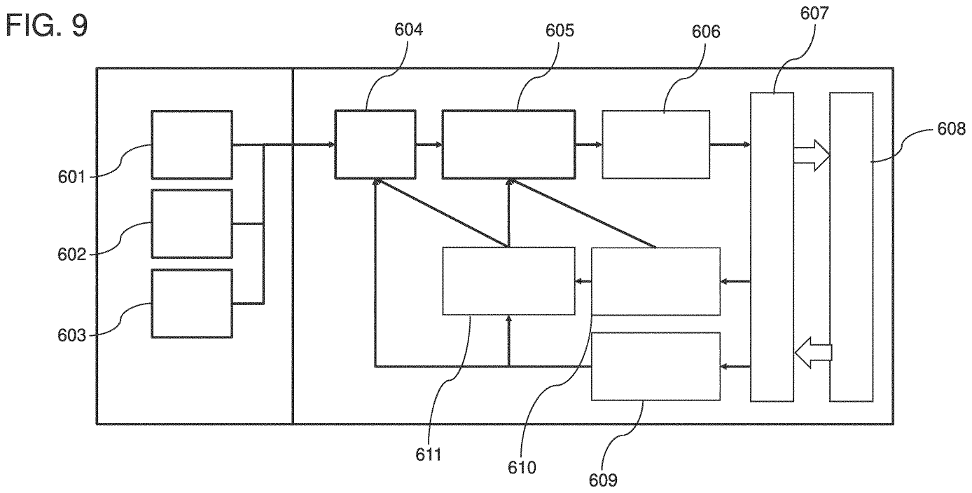

FIG. 9 is an illustration of a regulation system of the electric drive 100 according to one embodiment. The regulation system shown in FIG. 9 provides the modulation according to the disclosure. By way of the modulation 606, the regulation system provides a target output voltage to the electric drive, represented by the hardware 608 and a frequency converter 607. To provide the target output voltage or to perform regulation, actual values of the electric drive 100 must be detected and provided to the computing unit 200. The current actual current can be determined via 609. Furthermore, the actual voltage 610 and the current rotational speed and speed can be determined. This can be done using specific sensors. A target current can be specified via the speed regulator 602. In 604, this target current is compared with the current actual current. Depending on the deviation between the actual current and the target current, the target voltage is increased. This target voltage is physically applied to the electric drive by way of a modulation according to the present disclosure. The present disclosure influences the modulation of the individual subsystems 110, 120 of the electric drive 100 in such a way that the maximum output voltage can be increased.

Finally, it should be noted that the description of the disclosure and the embodiments are absolutely not to be understood as limiting with regard to a specific physical implementation of the disclosure. All features explained and shown in connection with individual embodiments of the disclosure may be provided in different combinations in the subject matter according to the disclosure so as to implement their advantageous effects simultaneously.

Although the present disclosure has been fully described above by way of preferred embodiments, it is not limited thereto, but rather can be modified in numerous ways.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMERALS

100 Electric drive
110 First subsystem to be controlled
120 Second subsystem to be controlled
200 Computing unit
201 First interface
202 Second interface
203 Processor unit
204 Storage means
300 Drive system
501 Phase contact
502 GND connection
503 Positive intermediate circuit voltage connection
504 High-side control voltage
505 Low-side control voltage
506, 508 Resistor
507, 509 Capacitor
510, 511 Switch
512, 513 Diode
601 Position setting
602 Speed setting
603 Torque setting
604 Actual/target current comparison
605 Voltage compensation
606 Modulation
607 Frequency converter
608 Drive
609 Current detector
610 Voltage detector
611 Position/speed detector
V Method
S1-S5 Method steps

1. A method of controlling an electric drive, the method comprising:
dividing the electric drive into at least a first subsystem to be controlled having a first control range and a second subsystem to be controlled having a second control range, the first subsystem and the second subsystem collectively having a shared stator configured to drive a shared rotor of the electric drive;
acquiring a control vector for controlling the electric drive;
detecting a first control value in the first control range of the first subsystem, and detecting a second control value in the second control range of the second subsystem at a time when the control vector is acquired; and
assigning the acquired control vector to the first subsystem and to the second subsystem so as to control the electric drive in a specific ratio, in such a way that the first control value does not exceed a maximum control range of the first subsystem and/or the second control value does not exceed a maximum control range of the second subsystem.

2. The method of claim 1, wherein, at the specific ratio, the maximum control range of the first subsystem to be controlled and the maximum control range of the second subsystem are exceeded for a time range.

3. The method of claim 1, wherein the electric drive is configured as a brushless DC motor.

4. The method of claim 1, wherein the electric drive includes a stator arrangement provided with the shared stator and the shared rotor, wherein the shared stator is provided with twelve stator teeth or a multiple thereof and the shared rotor is provided with ten rotor poles or a multiple thereof.

5. The method of claim 1, wherein one subsystem of the at least first subsystem and the second subsystem to be controlled is configured as a master and the other subsystem(s) to be controlled are configured as a slave.

6. The method of claim 1, wherein the electric drive includes a drive with a number of phases n*3, where n is the number of phases and is a natural number ≥2.

7. The method of claim 1, wherein the assigning step includes maintaining the direction of the control vector and reducing a length of the control vector for a subsystem of the at least first subsystem and the second subsystem to be controlled.

8. The method of claim 1, wherein the assigning step includes setting the first or second control value to a maximum control range while simultaneously changing a direction of the control vector.

9. The method of claim 8, wherein, for the change of direction, a d-component or a q-component is kept constant while a Park transformation is performed, or an α-component or a β-component is kept constant while a Clarke transformation is performed.

10. The method of claim 1, wherein the assigning step is performed after an inverse Park transformation has been performed.

11. The method of claim 9, wherein the control value is set by setting the d-component or the q-component or both, or by setting the α-component or the β-component, or both.

12. The method of claim 1, wherein the assigning step includes setting a control value to the maximum control range while simultaneously minimizing a deviation from the acquired control vector.

13. The method of claim 1, wherein a subsystem of the at least first subsystem and the second subsystem to be controlled is operated at a control limit, even if a uniform resolution of the control vector would be possible.

14. A computing unit for controlling an electric drive, the computing unit comprising:
a processor unit configured to divide the electric drive into at least a first subsystem to be controlled having a first control range and a second subsystem to be controlled having a second control range, the first subsystem and the second subsystem having a shared stator and driving a shared rotor of the electric drive;
a first interface configured to acquire a control vector for controlling the electric drive; and
a second interface configured to detect a first control value in the control range of the first subsystem to be controlled and to detect a second control value in the second control range of the second subsystem to be controlled at a time when a control vector is acquired,
wherein the computing unit is configured to assign the acquired control vector to the first subsystem and to the second subsystem to control the electric drive in a specific ratio, such that the first control value does not exceed a maximum control range of the first subsystem and/or the second control value does not exceed a maximum control range of the second subsystem.

15. A drive system comprising an electric drive and the computing unit of claim 14 for controlling the electric drive.

16. The computing unit of claim 14, further comprising:
a computer program configured to be loaded to a storage unit of the computing unit and contains program code portions to cause the computing unit to:
acquiring a control vector for controlling the electric drive;
detecting the first control value in the control range of the first subsystem, and detecting the second control value in the second control range of the second subsystem at a time when the control vector is acquired;
assigning the acquired control vector to the first subsystem and to the second subsystem so as to control the electric drive in a specific ratio, in such a way that the first control value does not exceed a maximum control range of the first subsystem and/or the second control value does not exceed a maximum control range of the second subsystem.

17. The computing unit of claim 16, wherein at the same ratio, the maximum control range of the first subsystem to be controlled and the maximum control range of the second subsystem are exceeded for a time range.

18. The computing unit of claim 16, wherein the computer program is further configured to maintain a direction of the control vector and reduce a length of the control vector for a subsystem of the at least first subsystem and the second subsystem to be controlled.

19. The computing unit of claim 14, wherein the control vector is a voltage vector.

20. The computing unit of claim 19, wherein the computer program is further configured to keep constant a d-component or a q-component while a Park transformation is performed in order to change the direction of the control vector.
